(19) United States
(12) Patent Application Publication
(10) Pub. No.: US 2015/0094096 A1
(43) Pub. Date: Apr. 2, 2015

(54) LOCATION AND EVENT BASED INFORMATION EXCHANGE AND CONTROL SYSTEM

(71) Applicants: Xueming Tang, Canton, MI (US); Hai Yu, Canton, MI (US)

(72) Inventors: Xueming Tang, Canton, MI (US); Hai Yu, Canton, MI (US)

(21) Appl. No.: 14/043,828

(22) Filed: Oct. 1, 2013

(51) Int. Cl. H04W 4/04; H04W 4/20

(52) U.S. Cl. CPC H04W 4/04; H04W 4/206
USPC 455/456.3

(57) ABSTRACT

An information system that provides information exchange and control services based on location and event between a subject of information and a service user. The information system first builds up direct referral link between the information resource and the subject of information by referral of a common map location. Information exchange and system control connections between them may also be established. The service next builds up information exchange and system control connections between the information resource and the service user intelligently and dynamically by satisfying conditions that comprises spatial and behavioral relationships and information subject matching rules. After that, information exchange and control channel is indirectly established between the service user and the physical existence of the information subject through the connection provided by the service of information resource, which manages the controllability of the subject and the contents and accessibility of the information related to the subject.

### CROSS-REFERENCE TO RELATED APPLICATIONS

This application is a continuation of U.S. Provisional Patent Application Ser. No. 61/709,151

### TECHNICAL FIELD

One or more embodiments relate to a class of computer program-level services and methods for controlling information exchange, data communication, system operation command and service application programs based on a referral map location of an information subject and the map position of a service user as well as the geographical and behavioral relationships between them.

### BACKGROUND

Internet and website based information sharing and exchanging system has been successfully expanding our information sharing capability in the last twenty years. The Internet carries an extensive range of information resources and services, such as the inter-linked hypertext documents of the World Wide Web (WWW) and the infrastructure to support email. However, the information system solely based on internet protocol (IP) and websites is inefficient in satisfying the need of individual and immediate information exchanging and control services. This is mainly due to its indirect connection between the service user and the subject of information, especially for the subjects that have physical existence. Other obstacles for regular service users include the high cost in establishing and maintaining a website, the technical obstacle of making hypertext webpages and links, and its dependency on search engine to find related information contents, etc.

These problems associated to the Internet and website based information system have made it hard for unskilled and common information service users, like small business owners and housewives, to have a place or network space to post and exchange their information timely and cost-effectively with others who have high and immediate interest. Even for skilled internet users, the amount of time and effort used to search for certain information contents on the websites and to find useful information from a large amount of data are frequently significant and very unproductive. More importantly, the subject of information has an important role in information society and informatization construction. The existing information system is incapable to provide smart and connected information services such that the information content and subject provided to the user have strong correlations and connections to the service user's life and behaviors.

To solve these identified insufficiency and to bring the next generation object-oriented information resource and service technology to reality, this invention presents the location and event based information exchange and control service system that first builds up direct referral link between the information resource and the subject of information by referral of a common map location. Information exchange and system control connections between them may also be established. The service next builds up information exchange and system control connections between the information resource and the service user intelligently and dynamically by satisfying conditions that comprises geographical and behavioral relationships and information service rules. After that, information exchange and control channel is indirectly established between the service user and the physical existence of the information subject through the connection provided by the service of information resource, which manages the accessibility of the information contents and applications related to the information subject.

The basic motivation of the innovative map location and event based information resource and service system is that a large amount of information is related to certain topics and subjects. And, most of the information in need has strong connection to an information service user's life and activity including position, environment, time, social status or identification, behavior and intention, etc. In this invented information service system, the information subject is called landmark and the information resource is a landmark account on the information service system. A registered landmark account is associated to a declared landmark by referring to the location of the landmark in its identity definition.

First, in this system, any user can create information account to post and exchange information that relate to a physical existence referred by a map location without relying on IP, WWW or hypertext webpages. For example, a housewife can declare her house as a landmark and post yard sale information on its landmark account using simple text messages. There will be no technique obstacle for maintaining the information resource and information contents, no website cost and no waste on advertising a website to unrelated and uninterested information users. Second, information related to the same subject can be high efficiently organized with well-targeted contents and user groups by referring to a common place, institute or organization. Based on virtual or physical position, a service user having strong relationship with a place will be connected to an landmark account that refers to a declared landmark for the place. The information contents provided by the service have strong correlation with the service users' activity and information in need through reasoning about where the user is and what the user is interested in. By referring to a common place, the information exchange and control channel between the information service provider and the service user is more directly and immediately established, and its capability is largely extended. As a result, the cost on information resource and service maintenance and the effort in locating useful information content are all optimally minimized.

Besides the map location and event based information resource and service system, this novel and state-of-the-art object-oriented information exchange and control service concept has also been extended to objects other than fixed existence of information subjects. The advanced categories of objects include: 1. mobile agent objects such as people, vehicle, animal, and groups of moving objects, etc.; 2. conceptual objects such as human-defined and virtual reality objects like health, attitude, mode, etc.; 3. description and image objects such as a descriptive context, a portrait or image of an object.

In general, based on the present internet and mobile communication systems, the newly invented information exchange and control technologies construct a Where-Who-When-What System (4WS) that can build up more direct and effective information connection between the service user, the information source and the subject of information that are separated in the presently available communication and information systems.

### SUMMARY

The following summary provides an overview of various aspects of exemplary implementations of the invention. This summary is not intended to provide an exhaustive description of all of the important aspects of the invention, or to define the scope of the inventions. Rather, this summary is intended to serve as introduction to the following description of illustrative embodiments.

In a preferred embodiment of this invention, an information service system provides information exchange and application services between a landmark and a service user. The invention disclosed and claimed herein, in one aspect thereof, comprises a system and methodology for defining a landmark and registering a landmark account with identity reference to the location that has been declared for the landmark. The landmark client account is used to store information and applications associated to the landmark on the information service system. Furthermore, relationship condition based information access rules are formulated for landmark account. These rules specify on relationship condition between the landmark and service users for granting access to stored information and applications as well as methods for authorized usages and operations.

One novel feature of the client connection and information access control services is to evaluate the relationship condition between a landmark client and a user client. A first relationship condition is a subscription condition through which a service user subscribes information and application services from a landmark account. A second relationship condition is a filtering condition through which a service user accepts qualified information and application services provided from a landmark account. A third relationship condition is an event condition through which a service user accesses information and application services from said landmark account under prescribed event.

In another aspect of the invention, a service user connects to the information service system via a user account. Event based information and application access policies are formulated for service user account. These policies specify on interested information services and the relationship situations between landmark clients and the service user for granting such services provided from landmark accounts. An event characterizes a relationship situation between a landmark and a service user with conditions comprising user and landmark identity, time, geographical and behavioral relationships.

In yet some embodiments of the information service system, a service user has client terminal device systems connected to the information service system. For such client, an information exchange and application service connected to such user further includes communicating information and applications with the client terminal device systems and applying such information and applications on the client terminal device systems.

Additional features and advantages of the invention will be made apparent from the following detailed description of illustrative embodiments.

### BRIEF DESCRIPTION OF THE DRAWINGS

FIG. 1 is a schematic diagram of a 4WS information exchange and control service system that connects the service user to the information resource and the information subject based on the geographical and behavioral relationships between them according to one or more embodiments;

FIG. 2 is a schematic diagram of the map location and event based information system of FIG. 1, illustrating its components and communication topology between its service application servers and different subsystems;

FIG. 3 is an illustration of information landmark definition method on a point type of map location.

FIG. 4 is another illustration of information landmark definition method on a shaped region type of map location.

FIG. 5 is a flow chart illustrating a method for declaring a map location as an information landmark and establishing a landmark information account for the declared landmark.

FIG. 6 is a flow chart illustrating a method for direct accessing information from a landmark information account according to one or more embodiments;

FIG. 7 is a flow chart illustrating a method for subscribing information from a set of selected landmark accounts according to one or more embodiments;

FIG. 8 is a flow chart illustrating a method for selecting an active landmark for information exchange and control service based on navigation process and event according to one or more embodiments;

FIG. 9 is a flow chart illustrating a method for updating local landmark database on a user's terminal application device according to one or more embodiments.

FIG. 10 is a flow chart illustrating a method for randomly selecting active landmark account for information exchange and control service if landmark and landmark information filtering conditions are satisfied according to one or more embodiments.

FIG. 11 is a flow chart illustrating a method for the LEPS to select active landmark account for a user who requesting service by matching their landmark and information filtering rules besides the location and event matching conditions according to one or more embodiments.

FIG. 12 is a flow chart illustrating a method for the candidate active landmark set preparation process in LEPS to select active landmark account according to one or more embodiments.

FIG. 13 is a flow chart illustrating a method for the user and candidate landmark paring process in LEPS to generate the active landmark set according to one or more embodiments.

FIG. 14 is a flow chart illustrating a method for the IECS to manage the information exchange and control process among the landmark place, the landmark account and the service user to realize the 4WS communication service according to one or more embodiments.

FIG. 15 is a flow chart illustrating a method for the information and control updating process in IECS to manage the landmark information exchange and record in absence of new landmark and user pairing data according to one or more embodiments.

FIG. 16 is a flow chart illustrating a method for the landmark information retrieving and communication process in IECS to identify the requested and allowed landmark information from landmark accounts and to communicate the information to the user's service terminal devices according to one or more embodiments.

FIG. 17 is a flow chart illustrating a method for the landmark information and updating process in IECS to update contents on existing landmark accounts and to manage new landmark account requests accounts according to one or more embodiments.

FIG. 18 is a flow chart illustrating a method for the landmark system control process in IECS to control systems associated to landmarks according to one or more embodiments.

FIG. 19 is a flow chart illustrating a method for the user terminal device system control process in IECS to control systems associated to user's terminal device according to one or more embodiments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present invention presents a new information system developed for facilitating information exchanging and control services based on physical or virtual existence locations of objects on maps. The map can be a universal map, like geographic map where any object can be located by map coordinates both on the map and in real world. Alternatively, a map can be defined based on coordinates from a local positioning system, like a building floor map, exhibition layout map, etc. A map location is a visual representation of the physical existence of a place and a symbolic depiction highlighting relationships between elements of that space such as objects, regions, and themes. The physical existence of the map location is the subject of the information in the 4WS information exchange and control system and it is defined as an object on the map with coordinate and boundary. A map location is defined with map coordinates and geometric shape. It can be a position, a site, a zone, an area/region/country, a building, a plant, or even a planet, etc. It can also be a group or combination of the afore-mentioned objects.

Once a map location is properly defined and located, it can be declared as information landmark, or simply landmark. A unique identification including name, address and geographic location, digital or descriptive identifier, will be assigned to the declared landmark. Then, on the 4WS service center system, an information account will be established with storage space allocated to keep all the records of the declared landmark and to store all the uploaded information that is associated or related to the declared landmark. In other word, a landmark information account is the information resource to the declared physical existence of a map location. Landmark account properties will also be configured for the declared landmark account and it saves all the account features, attributes and information exchange and control rules specified by users and the landmark information system. A landmark account may contain control application program, command set and methods that can be used to operate 4WS service client terminal devices. For a landmark place that has control system and control function provided, the landmark account also contain control application program, command set and methods that enable a 4WS service user to access the control system and to use such functionalities with allowable operations.

The service user who declares a landmark location for information service is the initial owner of the landmark account and this user is granted landmark host service rights. Information associated to the declared landmark can be uploaded to the storage space on the 4WS information exchange and control server or a third party information storage provider. Such information is mainly in the format of computer data file, table or text and computer programs include, but not limited to, symbol, text, audio or video records, figures, album, advertisement, control commands, application programs, forum, bulletin board, webpages, website or webpage links, etc. The landmark host has the right to manage the landmark record and information contents as well as to determine the rules for the landmark information exchange and control methods, restriction, update and modification, control executions, etc.

On the other hand, a regular 4WS service user is the customer other than the landmark owner that have information obtained from and sent to a landmark account using the map location and event based information exchange and control service. A regular landmark user has limited right in accessing and managing the landmark information content and records. A landmark information and control user has to follow the rule specified by the landmark host and the service provider. Using 4WS service user account and profile, a regular landmark user can claim ownership to the information content or controls he/she contributed to a landmark account. In that role, a user has more rights to manage the associated landmark contents and functions with more advanced operation options and responsibilities.

The connection and communication for information exchange and control between the real landmark place (the physical existence of the information subject as a location or a system), the landmark information resource and the service user are established through referral of geographical relationship and event recognition methods. First the landmark information account is directly associated to its declared landmark place by referring to the map location of the landmark place. Communication connections for information exchange and controls may also be established between the landmark place and the landmark account on the information service system.

The service next builds up information control and exchange connection between landmark accounts and service users dynamically by detecting the satisfaction of events. An event is an occurrence of certain geographical relationships between a service user and a landmark place together with specified behavioral, spatial, time and environmental conditions. An event further prescribes the allowable information exchange permission and control accessibility.

On the information service center system, application programs for event reasoning and recognition constructs the core for connecting users to the information, functions and knowledge associated to landmark places through their landmark information accounts. In general, the event processing algorithm implements the where (geographical position and relationship), who (user and landmark), when (time and duration) and what (behavior and activity) conditions based information exchange and control connection principles. After a satisfying event is detected, information exchange and control channel is established between service users and landmark accounts through the service of information resource. Further connect between users and landmark places/systems can also be established. The information service manages the accessibility of the landmark information contents and control functions.

There are different ways to build up information exchange and control connection between a service user and a landmark place using the map location and event based 4WS information services. One of the primary methods builds up the connection utilizing mobile navigation devices. An exemplary navigation device is a GPS device that receives Global Positioning System (GPS) signals for the purpose of determining the device's current location (latitude, longitude, and altitude) and time on Earth, as well as the derived heading direction, velocity, acceleration from the afore-mentioned base signals and their history records. Most importantly, a service user's navigation behaviors and the geographic relationship between the user and a landmark place can be mathematically modeled from these navigation signals when a navigation device is attached to the user or to the service application terminal device of the user. The landmark place will be selected as an active information subject when the user's navigation behaviors and their geographic relationship satisfy pre-specified conditions both from the landmark's information account and from the service user's account as well as other information filtering and accessibility conditions. Subsequently, information exchange connection and control access between the user and the information account that refers to the landmark place will be established. After that, information and control command can be transmitted between the service user and the landmark information account. Such connection can be further extended with the information exchange and control connection between the landmark place and the information account declared for it. For example, the 4WS service center system activates a landmark account and transmit its information content to be displayed to a user when the user's GPS device reports that the user's geographical position is reaching, approaching, crossing to or staying in a landmark location in the real world. It is necessary to emphasize that such navigation based landmark selection and information access method can also be applied in virtual reality application environments, like navigation on a map or in a geographic information system.

Another primary method provides the user access to a landmark information account by directly selecting a landmark location on a map using 4WS information service application program on a networked terminal computer. Furthermore, landmark profiles can be established in the service user's account such that the user can book landmark information by select and access multiple landmark information accounts. Alternatively, the user can specify landmark filtering and information filtering rules such that information and control from landmark locations will be automatically transmitted to the user if the specified filtering and information updating conditions are satisfied.

A third primary method provided by the 4WS information service builds up information exchange and control connection between a service user and a landmark place by matching the communication and information accessibility rules specified both by the user and by the service provider without explicit referral to any landmark location. In this way, information from a landmark information account will be automatically transmitted to the user if only the account access of the user is permitted and the information content is allowed both by the landmark account information provider and by the service user. Such permission and accessibility are determined not only from the property and attributes of landmark account and the service user account but also from the geographic coverage and filtering rules from both accounts. Information broadcast with certain regional coverage from a landmark information account can be realized in this manner.

A landmark information account is the information resource with referral to the physical existence of a location or a system through geographic position and relationship links. A declared landmark has its unique name, address, location (coordinates, boundary, geographic shape and information coverage range, etc.), and account configurations (type, category, property, attributes, priority, information exchange rules and control functionalities, etc.). Exemplary categories include but not limited to: restaurant, grocery store, church, government agent, parking place, school, pharmacy, theme park, etc. Multiple landmarks that have different name and configurations can declare on the same map location. Landmarks are defined with individual map scale and location coverage. Overlap and inclusion among landmarks are allowed. For example, from the earth scale, the map of the United State is a landmark and the information related to the country will be saved, shared and exchanged using the US landmark account and associated information saving, updating and exchanging rules. In a much small scale, for example the street view scale, a dental clinic is declared as a landmark and information associated to the clinic, like welcome message, promotion, coupon, clinic history, dentistry description, can be posted, shared and broadcasted.

The information contents on a landmark account are also organized in classified categorizes and is specified with sharing rules, control methods, restrictions and priority. The category is further organized in a hierarchical structure to facilitate searching, classification and indexing. The landmark host determines the methods and rules that the information from the declared landmark account is exchanged and the control function and command set that can be realized at the landmark place. A landmark user can specify the method and content of the landmark information that is transmitted to the user and the information content and control method that are transmitted from the user.

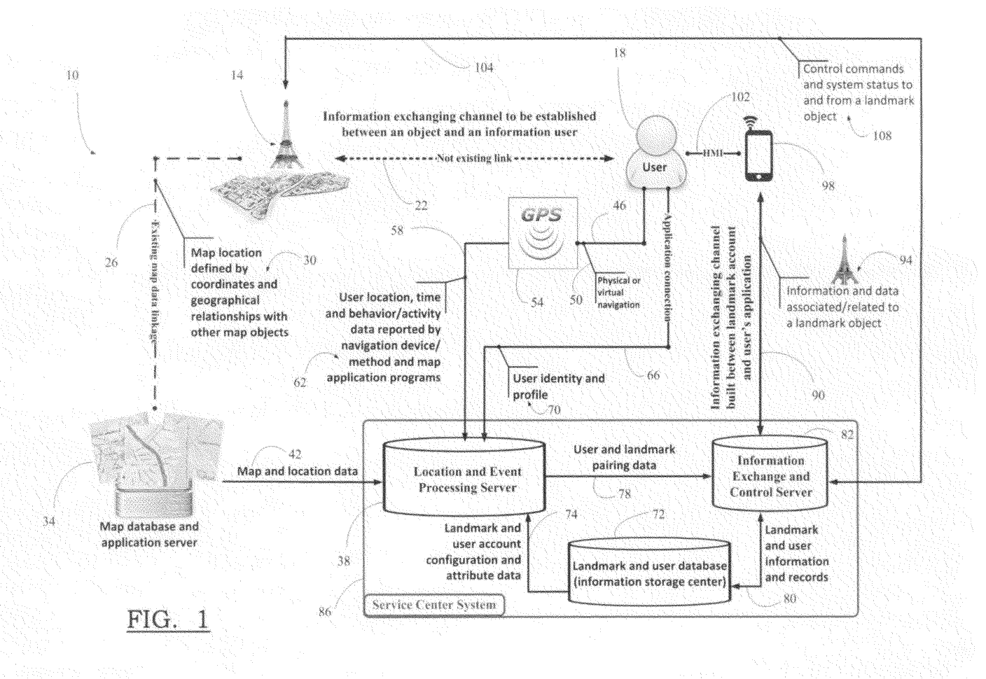

With reference to FIG. 1, an information system for information exchange and control between a landmark place and a service user based on their geographical relationship and event recognition is illustrated in accordance with one or more embodiments and is generally referenced by numeral 10. The information system 10 comprises an information and communication network that includes a landmark place 14, a user 18, a 4WS service center system 86, and a map database 34. The map database provides uniformly and consistently defined geographic coordinates and relationship data both to the user's navigation device and to a location and event processing server (LEPS) 38 on the service center system 86. The map database 34 is not necessarily centralized but it is centrally represented in this figure.

The illustrated embodiment depicts the landmark place 14 as the Eiffel tower, which has map coordinates defined for its position and boundary as well as its geographic relationships with other map objects 30. Such geographic data 30 had been pre-established through cartography measurements 26. The landmark place 14 is the information subject and it has been declared on the 4WS service center system 86 with a landmark information account that is referred by the same geographic map location as the landmark place. The landmark information account is the information resource to the information subject and it contains all the record and information that relates to the landmark subject place. Through the 4WS service center system 86, the landmark information account on a landmark database and information exchange server 82 may have communication connection 104 to the landmark place to enable information exchange and control between them 108.

In one embodiment, landmark 14 is the place to which the user 18 wants have information exchange and control access. The landmark 14 can also be a system that contains functionality that can be controlled by receiving commands from the user 18. In another embodiment, information related to the landmark place 14 would like to be transmitted to the user 18 or to control the functionality available at the user's client terminal device 98. Such information exchange and control connections between the landmark place 14 and the user 18 is depicted by the dotted line 22, which does not physically exist or cannot be realized directly.

The user 18 has access to navigation function 46 by carrying a navigation device 54 or by having a navigation device attached to/equipped on the user's client terminal device 98. Alternatively, such navigation function 46 can be realized in a virtual reality environment like map based computer software programs. In one embodiment, the navigation function can be provided by a GPS device 54 that reports the user's position, directions, velocities, accelerations, trajectory and future route on map. In another embodiment, the virtual navigation can be a Google maps or Google earth application on a computer such that the user navigates to a map position without physically at there. The virtual navigation function can report data that includes the selected map center position, map scale, map range and region coverage, map displaying mode, map navigation direction and moving speed, etc.

The navigation system 54 has communication connection 58 to report the user's location, time and behavior/activity data to LEPS 38. The user 18 also has communication connection 66 to LEPS 38 to report user identity and user profile 70 such that LEPS 38 knows for whom and from where the information is requested. All these communication connections can be realized through the communication network between the user's client terminal device 98 and the 4WS service center system 86. The LEPS 38 also obtains map and location data 42 from the map database and application server 34.

After receiving the user's identity 70, the LEPS 38 will retrieve the user account information, account settings and configurations 74 from a Landmark and User Database (LUD) 72, which is an information storage center station. The LEPS 38 then determines the set of conditions for landmark selection and information filtering based on the user account settings and configuration parameters 74. From LUD 72, the LEPS will screen landmark accounts and determine an initial set of landmark accounts that satisfy these conditions and that allow information exchange and control with the user. By further processing these user and landmark information with reference to the map and location data 42, the LEPS 38 now not only knows what information is requested for whom and from where, but also knows the user's navigation behavioral and geographic relationships to the initial selected landmark places. Optionally with time, an event will then be recognized by LEPS 38 with respect to a landmark place. For example, at 11 am, user A's position is within the information coverage range of landmark place B, user A is driving in the direction towards landmark place B at a speed of 20 mph and user A is expected to cross landmark place B in 5 minutes. Another example can simply be user A is crossing landmark region B.

After an event has been recognized with respect to a landmark place from the initial selected landmark set, conditions and parameters of such event will be compared to the qualified event specifications both from the landmark information account and from the user account. Once a match between the event occurrence and the event specifications is satisfied, the user and the landmark account will be paired for information exchange and control connection establishment. The user and landmark pairing data 78 will then be transferred to an Information Exchange and Control Server (IECS) 82 to build up information exchange and control connections between the user and the landmark information account. The paired landmark account to a user is also called a user-oriented active landmark, or simply active landmark. Such pairing process will be repeated on the LEPS 38 for all the initial selected set of landmark accounts.

After receiving the user and landmark pairing data, the IECS 82 will establish and confirm the communication connection to the user's client terminal device 98, and optionally to the landmark place, through a wired or wireless communication network using IP address and network terminal address. Embodiments of such communication networks include the internet, intranet, mobile networks, cellular network, Wi-Fi, etc. The information exchange and control methods through the established communication channels have many techniques as will be presented later.

A landmark information account is a virtual representation to the real landmark place. It is a knowledge library that contains all the information about or indirectly related to the physical landmark place. The LUD 72 contains a database of landmark information accounts that store the records, account configuration and property, landmark information and control methods that are associated to landmark places 14. The LUD 72 also contains a user database that stores the records, account configuration and property, settings and control methods of service user accounts. Such a storage center can have a centralized or distributed storage architecture, which means that the information on the storage center can be centrally organized. Alternatively, it can be distributed to multiple storage data centers. Account identity and settings from both the landmark account and the user account will be provided to LEPS 74 for information exchanging and control pairing between the information subject and the information user. The information contents and control methods from active landmark information accounts will be retrieved and delivered to IECS 82 to realize the 4WS functionality between the information subject, information resource and the service user.

One embodiment of the 4WS functionality is to transmit landmark account information to the user's client terminal device 98. From the user and landmark pairing data 78, IECS 82 recognize what information from which landmark account is to be transmitted to which network communication address and in what format. The information content will then be loaded to the IECS 82 from the storage place of the identified landmark account. The information content will then be processed into specified format and delivered to the established communication channel. After the information content is received at the user's client terminal device 98. The information will be processed by general 4WS terminal application programs or by landmark account specified application programs and then it will be presented by the user through the Human Machine Interface (HMI) 102. The HMI communicates the information to the user in many manners including visual display, audio or haptic motion, etc.

A second embodiment of the 4WS functionality is to transmit landmark account information from the user's client terminal device 98. When a landmark is in active status on the user's client terminal device 98, communication channel between the 4WS application on the user's terminal device and the landmark information account on the 4WS service center system 86 has been established. When the user input new information for the client terminal device 98. The content of the information and other operation record and command will be transmitted to IECS 82. IECS 82 may further process the received information in certain format and locate the address of the active landmark account that is expected to deposit the uploaded information. Once the storage address is found and the storage permission is received from the landmark storage space on the LUD 80, the uploaded information and records from the user will be saved to the landmark information resource. Such information may also be appended with properties like information contributor's user ID, time, category, attributes, and information exchange restriction and sharing rules specified both from the user and the 4WS landmark application programs on the user's terminal device and the IECS 82.

A third embodiment of the 4WS functionality is for a landmark place that contains systems to provide control functionality to the service. The communication channel between the IECS 82 and the landmark place/system will be maintained or it will be established once the landmark is selected to be active for a service user by LEPS 38. The functionality provided at a landmark place can be realized by operating the systems at the landmark place with operation command from a control command set. Advanced system function may be realized with controllers that contains control algorithms either on the user's client terminal device 98 or on the IECS 82 with predefined control inputs and control outputs. The systems at the landmark place may also report system states, operation status, operation condition and allowable operations to the IECS 82. Such information can be saved to the landmark information account at LUD 80 or it can be sent to the users who have the landmark place selected as active and have the control function authority and control methods provided by application programs on the user's terminal devices. When control commands or control inputs are generated from the user's terminal device, such control information will be received from the IECS 82 after control and communication channel between the client terminal device 98 and the IECS 82 has been established and confirmed. According to the control implementation command associated to the received control commands/inputs, such control information can be transmitted to the system at the landmark place immediately for control function execution. Alternatively, the control information can be saved to the LUD 80 or conserved to IECS 82. The control commands/inputs can then be sent to the systems on the landmark place for execution when certain time, state or status conditions will be satisfied.

A forth embodiment of the 4WS service give the control authority and functionality to systems on the landmark place to control and operate the user's terminal device. In this mode, functions and control methods allowed by the user's terminal device will be reported and saved on the user's account with a profile containing all the information associated to a certain terminal device. When selected as an active landmark and when a match has been recognized between the allowable control functions/methods on the user's terminal device and the control operations from the landmark account, executions of the control function will be carried out given satisfying all the associated execution conditions on time, state, status and permissions. The user's terminal device will report its time, states, status and allowable operations to the IECS 82. Thereafter, the device information will be processed by the landmark associated application program from the landmark information account to generate instructive or reactive control commands or inputs. Alternatively, such control commands or inputs can be received from the systems at the landmark place in the meantime. And then, these control commands and inputs will be sent to the user's client terminal device 98 from IECS 82 to implement. In this way, control information from the user's terminal device, including the states, status and allowing operations, will be reported from IECS 82 to the systems at the landmark place 14 as well.

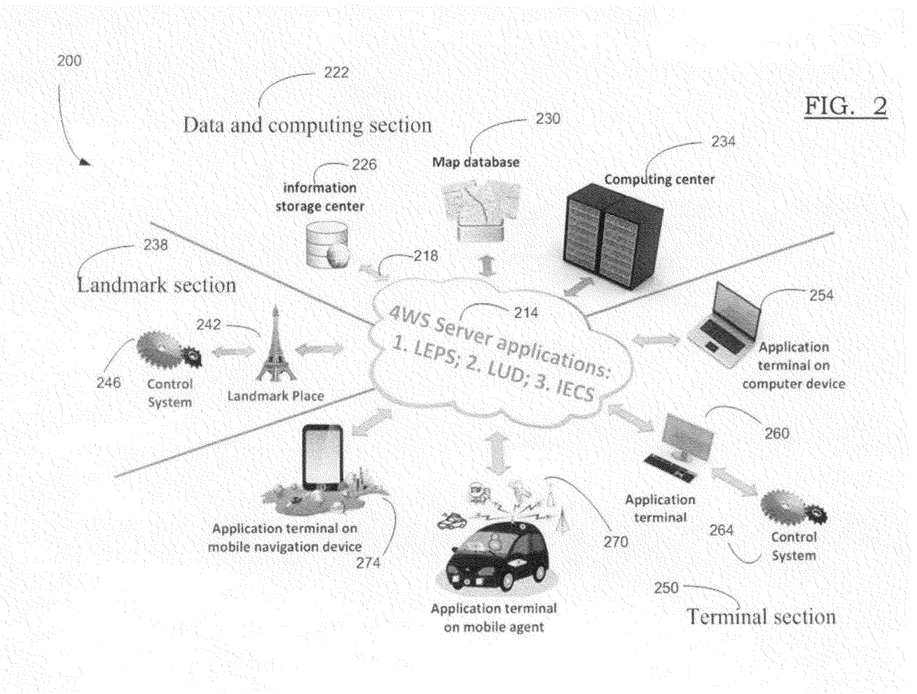

As illustrated in FIG. 2, the map location and event based 4WS information exchange and control system 200 comprise four sections of components: the service center system 214; the data and computing section 222; the landmark section 238 and the terminal section 250.

The service center system 214 comprises all the computer programs to provide and to support the 4WS information exchange and control service. It is an application platform where the information and controls from the landmarks and users got managed and transmitted to appropriate data storage places or application terminals. The operations of these programs enable functionalities of service center system including LEPS 38, LUD 72 and IECS 82. All the data, information and control signals from the rest of the systems are being processed on this server. The server has bidirectional communication access 218 with components from the rest three sections. Such communication access 218 comprises wired communication networks (Internet, Intranet, etc.) and wireless networks (Wi-Fi, Bluetooth, Cellular network, etc.). And the communication access 218 represents all the bidirectional arrows on FIG. 2.

The data and computing section 222 comprise the information storage center 226, the map database 230 and the computing center 234. The information storage center 226 provides the data storage space for all the data used by the 4WS information system. Such data include landmark and user account records, settings, the information contents for exchange and control and their associated history records.

The map database 230 is the same as the map database 34 on FIG. 1, but the map data processing algorithms and application programs are lumped to the service center system 214. All the map data defined to support the 4WS functionality are deposited on this database. Such data defines geographic positions of objects and places on earth as well as their geographic and relative relationships with other objects and places. Furthermore, for moving objects, their navigation and behavioral relationships with respect to the map coordinate system and other objects/places can also be determined based on the map data. Besides the global geographic map data, the map database 230 also contains locally defined map data like building map, park map, exhibition map, etc.

The computing center 234 is a super computer center and/or a cloud computer center that provides computing capability and memory for running the 4WS application programs and data processing algorithms.

The landmark section 238 is mainly the landmark place 242 and the systems 246 that can be operated or controlled at the site of the landmark. Both the landmark place and the landmark system can also send information and control command/program to components from other sections of the 4WS information exchange and control system.

The terminal section 250 comprises different types of 4WS client terminal devices for information exchange and control. These devices have control and communication interface to a user and a system to be operated. Typical 4WS service terminal devices include but not limited to: a computer 254 (desktop, laptop or tablet), a smartphone or navigation device 274, a vehicle 270, a control system 264 via an optional application terminal 260, etc. The application terminal devices provide to the service users different types of interfaces to the 4WS information exchange and control system.

The terminal device 254 represents a group of 4WS service application running on computers. From such computer device, a user can navigate on maps, define map location, declare landmark place on map, establish and setup landmark information account, apply and setup user account and profiles, input information for exchange, obtain information from landmark account and other terminals, receive information in a certain manner (audio, video, display, etc.), run programs to process landmark information and control commands, generate control commands to operate a landmark place and system, program information exchange and control procedure and scheme, download and upload information exchange and control programs, etc.

The terminal device 260 connects to a control system 264. Terminal application programs to support 4WS information exchange and control are running on the device 260. Special data processing and control programs downloaded from a landmark account are also running on the device 260 such that the information related to a landmark place can be processed and interpreted in appropriate format after the landmark information is transmitted from a landmark account to this terminal device. For control purpose, other application programs may be downloaded from the landmark account and such programs contain the allowable control commands and methods to operate the control system 246 at the landmark place 242. The terminal device 260 also runs the operation and control programs that allow execution of control command and method from a landmark place 242, a landmark system 246 or other application terminal devices. Such control execution will maintain or change the states and status of the control system 264 or it will result in information exchange with the control system 264.

The control system at the landmark place 246 and the control system at the application terminal 264 are systems that provide certain functionality for information exchange and display or for changing or maintaining certain system states. For example, the control system at the landmark place is a lighting system whose lighting sequence and pattern can be changed to light different area or to form a certain light figures. For another example, the control system at the user's terminal device is a vehicle's speed controller whose upper speed limit can be adjusted by command either from the system at the landmark place or from the landmark account such that vehicles in the speed control zone landmark will not exceed the regulatory speed limit. To operate a control system, control command set and control methods are defined and provided by either at the landmark place or at the terminal device. Special control programs and algorithms may also need to be loaded onto the service center system 214 or on application terminal 260 to operate the control systems and to realize the service functionalities.

The terminal device 270 represents a group of mobile agents that include human operated vehicles, autonomous vehicles, robots, utility vehicles, etc. The vehicles can be car, truck, airplane, ship, submarine, etc. Such a group of mobile agents can drive from place to place. They have control and communication connections to the service center system. And they have navigation device to obtain their coordinate position, orientation, velocity and other derived geographic states and behavioral situations. Some of the mobile-agent devices also provide operation functions that can be externally controlled by commands from a landmark system, a landmark account and from service users. These mobile agents may report their system states and status to the service center system and receive landmark information and control commands from the service center system. Other than that, the mobile agent terminal devices can be used to support general location and event based 4WS service as terminal device 254. They can similarly serve as application terminal 260 to support a connected control system 264 as well. In these cases, the unique features of the mobile agents are their ability to move from place to place in the space where the map system is defined and their ability to determine the corresponding navigation data while in operation.

The terminal device 274 includes smart phones with navigation function and other types of navigation devices. In general, the function of this group of application terminal devices is similar to that of the mobile agent based devices except that they cannot move by themselves. In application, such terminal devices tell the navigation data and behaviors of objects that they are attached to. And they also serve as computer and communication terminal to transmit and receive data from the service center system. Meanwhile, application programs can also be applied on these terminal devices to process information and controls that are obtained from or to be sent to the service center system.

In order to declare a location on a map as an information and control landmark, the customer first load a 4WS service application computer program at a terminal device. When connection is established from the 4WS service terminal to the service center system, the 4WS application program on the server loads the map data from the map database and transmits the data in certain format according to the request from the 4WS application program onto the on the terminal device. The computer program on the terminal device receives map data and displays the map in certain map navigation view. Some type of terminal device may contain a local map database that is synchronized with the map database center 230.

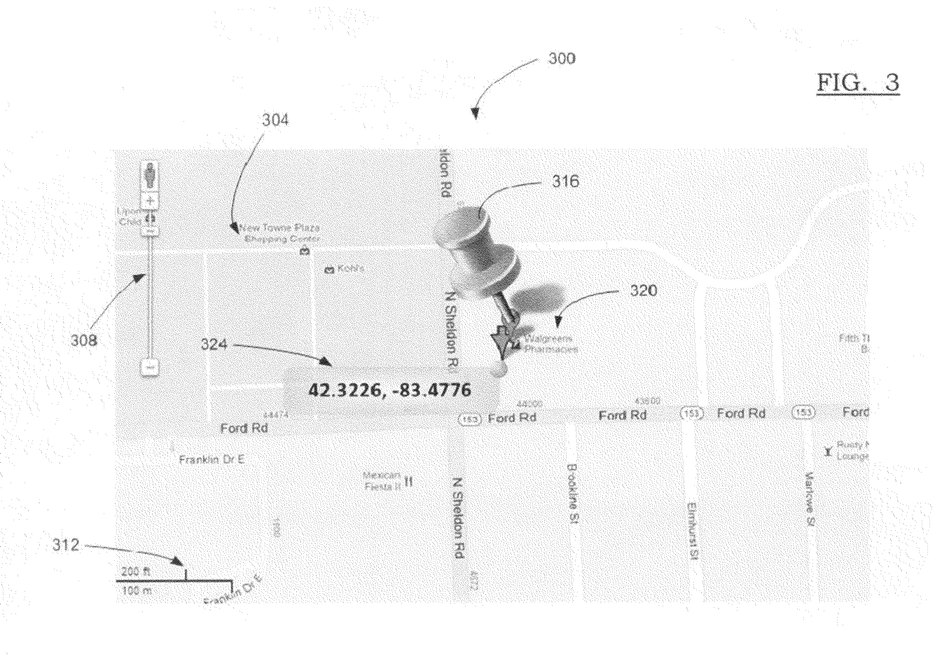

With reference to FIG. 3, a procedure to define a map location is illustrated in accordance with one or more embodiments and is generally referenced by numeral 300. From the 4WS service application program, load a map and display a target region 308 in proper scale 312. Select a position 320 on the map using a landmark locator tool 316 and obtain its coordinate data 324 on the map. Alternatively, relative coordinate with respect to a reference position on the map can be used. The map location identified can then be defined as a landmark location with the coordinate data 324. For example, as illustrated in FIG. 3, the position with coordinate data (42.3226, −83.4776) is defined by a landmark “Walgreens Pharmacies”.

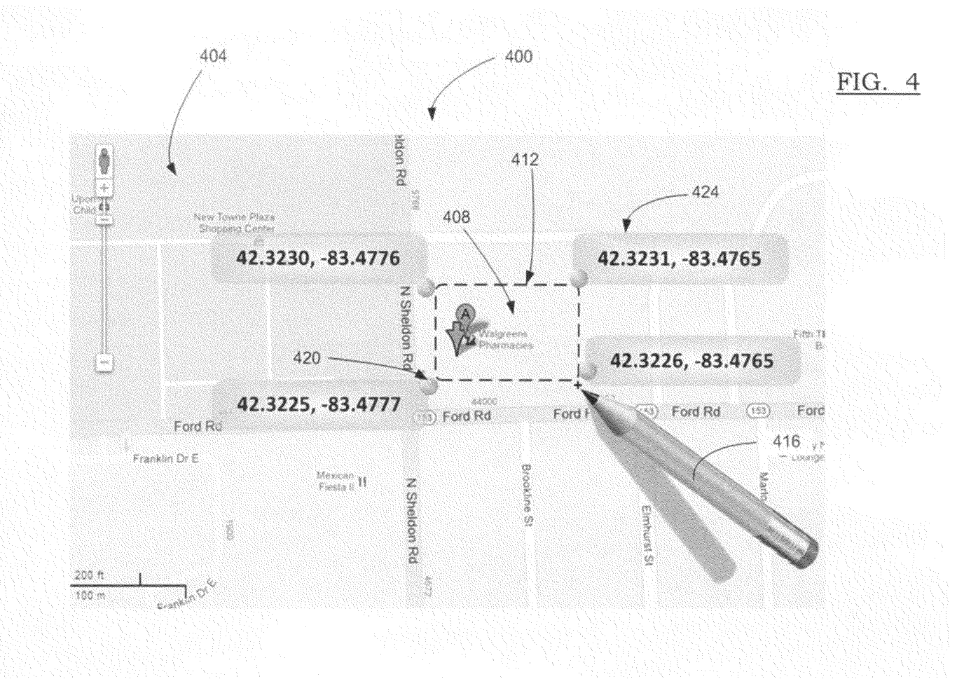

A second embodiment of landmark definition method defines a map location by a geometrically shaped area on a map. With reference to FIG. 4, a procedure to define a map region is illustrated in accordance with one or more embodiments and is generally referenced by numeral 400. After loading the map data and navigate to the target map area in proper map scale 404, a user uses landmark shaping tool 416 to select a map region in certain shapes. A set of characteristic points 420 are used to represent the defined lines 412 or the boundary of the shaped area 408. The coordinate data 424 of the set of points and their interpolated points determine the map location of the landmark to be declared. Lines or curves connecting all these points determine the boundary of the landmark. An illustrative example is shown in FIG. 4 where a “Walgreens Pharmacies” landmark is defined by a rectangular region.

In general, a map location can be defined by a point, a line, a trajectory, a route, connected lines and curves, connected lines and curves with enclosed map area, a shape or a group of shapes, a region or a combination of regions, etc. Alternatively, an existing object and a combination of existing objects on a map that has been pre-defined with map coordinates and geographic identifications can be declared as a landmark. Such objects includes but not limited to a building, a park, a road, a bridge, a institute or organization, a hill, a river, a lake, a country, a state, a plant, a highway/freeway road, an airport, a train station, a library, etc. Furthermore, existing landmarks defined can be grouped or combined to construct a new landmark place.

A map location for defining a landmark place is not necessarily stationery. Its map location definition can be varying with respect to time with changing coordinates definition its center, characteristic position and boundary. Such variable landmark place is useful to declaring information service zones like power outage zone, tornado zone, emergency control zone, etc.

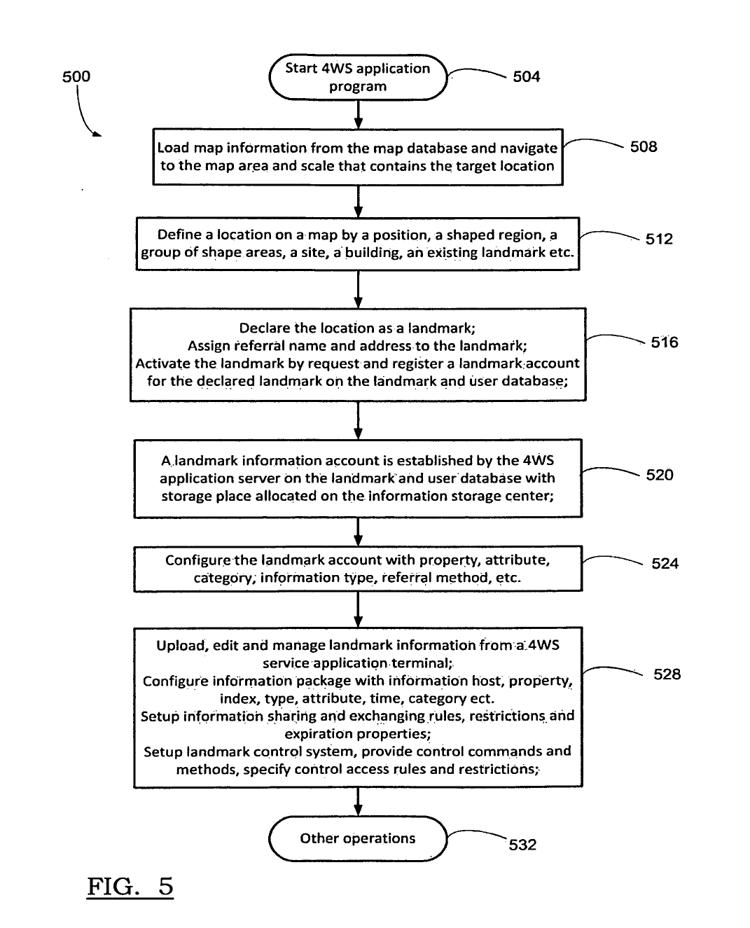

With reference to FIG. 5, a procedure to declare a map location as an information landmark is illustrated in accordance with one or more embodiments and is generally referenced by numeral 500. The process starts with starting service at 504 and loading the service application at 508. After a map location is defined with geographic identity at 512, a user next declares the specified map location as an information landmark at 516. The user gives a name to the declared landmark and specifies its associated category, attribute, property, etc. The declared landmark can also be identified both by its map identity or a descriptive address as well as other property and category identifiers. By declaring a landmark, the user also claims the ownership of the landmark account that will be established and associated to this landmark with referral to the landmark place's location and identities.

After a landmark is specified with its location on map, referral name and address, a landmark information account will be established on the LUD 72 at 520. Proper storage space will be allocated on the information storage center 226 to save related landmark account records, landmark information and controls (commands and methods). The landmark owner has administrative right to the landmark information and control account. It allows the landmark host user to setup the landmark account's configuration parameters, property, attributes, information exchange rules and restrictions, control system definition and control methods at 524. After finishing landmark account initialization and configuration, information related to a landmark place can be transmitted to its associated landmark information account at 528. Records about the landmark account activities are also managed and saved both by the service center system and the landmark host. This process ends and continues with other operations at 532.

When new landmark information reaches the server, the server application program will process, apply the data and save them to the referred landmark information account at the storage place. When the server receives new information request from a terminal, it will retrieve the requested landmark information from the storage center, process the data in the requested method and format, and transmit the information data to a user terminal device that is directed.

The information associated to a landmark in general has a subject directly or indirectly related to the landmark place. Such information includes, but not limited to data (in the format of symbol, text, message, audio or video records, figure etc.), controls (control and operation command, method, program, etc.), design (in the format of flyer, album, advertisement, etc.), software application program, and database (like data library, forum, bulletin board, webpages, etc.). For example, a restaurant landmark can contain information about history of the restaurant, menu, today's specials and coupon in flyer, audio or video format. A bus station landmark contains information about the general bus schedule at this station, the next bus coming time and route, and interactive route planning program for connection selection. A speed control zone landmark contains operation commands that can directly or indirectly control the operations of vehicles running inside the covered regulation region such that certain speed limit will not be violated.

A 4WS service user can generate and contribute any type of information to the landmark account using a 4WS application program from a 4WS service application terminal. Alternatively, contents of landmark information can be linked to the landmark account from other websites or information databases. The information on any landmark account are also organized in classified categorizes and is specified with attributes, exchange rules, restrictions and priority. The category is further organized in a hierarchical structure to facilitate searching and information sharing rule and information broadcast selections.

For example, a service provider wants to broadcast the service provided and give details about its type, history, price, available service time, updates and confirmation about appointments, etc. The service provider can declare on his/her office as a landmark and add the information be broadcasted to the landmark account hosted. On the same landmark account, service customer can add information related to the service provided at the landmark place, like appointment confirmation, service request, comments and customer reviews, etc. All the information will be classified into proper information categories on this landmark account with records of user's name/account name, time, and related service information.

For another example, a person can declare a landmark on his/her own house. When certain service is needed from the place, like plumbing service, the landmark owner can post service request from his/her landmark account and the information will be broadcasted and exchanged from the landmark account. Another user, who is a service provider, can look around on the map or from the application terminal about certain type of service requested from a region and contact the service request landmark owner to offer service.

When information is uploaded to a landmark account, it will be posted and exchanged among the 4WS service users in different methods. First, when a landmark is being selected from a 4WS application terminal's map navigator program, the information from the activated landmark account will be directly communicated to the user. Second, information from a landmark account can reach a user's application terminal device if the landmark is an active account that has been booked from the user's account in an information subscription manner. Third, the information from a landmark account will be transmitted to a user's 4WS application terminal devices when the user's navigation process satisfies certain geographical and behavioral relationships with the landmark location. Forth, information from a landmark account can reach a user's terminal device automatically when information exchanged is allowed with satisfaction of certain landmark filtering rules and/or information filtering rules.

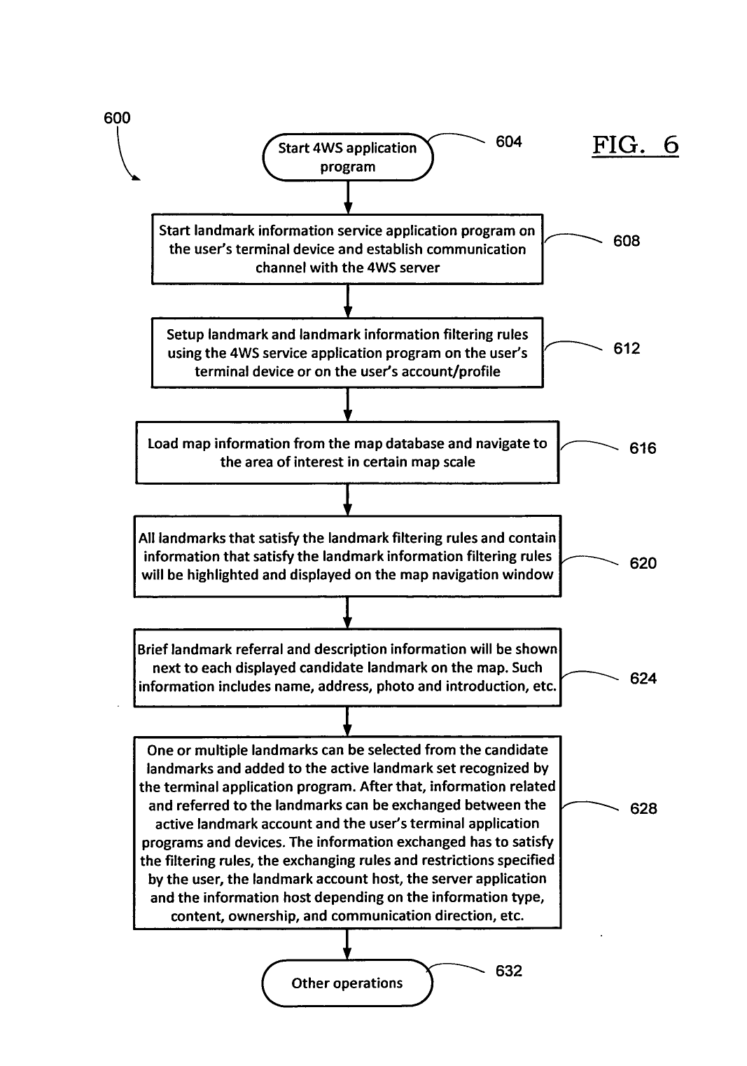

The first method to use landmark information is to directly access a landmark account on the information center. With reference to FIG. 6, a procedure to direct access information from a landmark account is illustrated in accordance with one or more embodiments and is generally referenced by numeral 600. After starting the 4WS service at 604 and starting the service program at 608, landmark selection filtering rules is setup to specify the scope of interested landmark by landmark identity, location, attribute and configuration parameters at 612. A landmark user first search for satisfying landmark in the landmark database or navigate to an interested map area at 616. All landmarks that satisfy the filtering rules will be heighted either in a selection list or on the map navigation widow at step 620. Brief landmark referral and description are also displayed next to the candidate landmark in the list or on the map at 624. After a target landmark is selected at step 628, the user then request landmark information from the landmark account at the landmark information center. A program from the landmark account or from the landmark information server will retrieve and process the requested landmark information and then transmit the data to the user's application terminal. The application program running at the application terminal will be able to use and apply the data as well as to communicate the data to the information user. In some cases, a special application program from the landmark account will be required to be loaded to the landmark information server and/or to be downloaded to the landmark application terminal device to support information processing and application. This process continues with other operations at step 632.

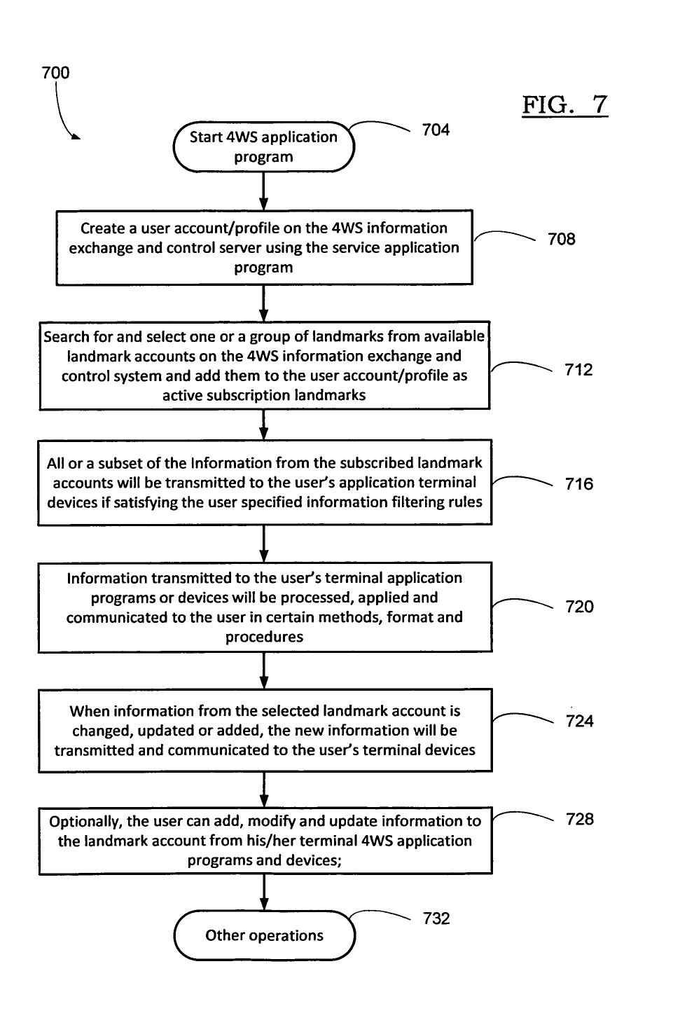

With reference to FIG. 7, a procedure to subscribe to landmark information is illustrated in accordance with one or more embodiments and is generally referenced by numeral 700. After starting 4WS service at 704, a landmark subscription account or profile can be created under a user account on the landmark information center at 708. Through such information subscription account, the landmark user can first select and add interested landmarks to the subscription account by direct selection or by searching or filtering through a set of landmark selection conditions at 712. Next, the subscription account user can book information from selected landmark accounts and get updated when new landmark information is posted on the landmark accounts at 716. All or a subset of the information from the selected landmark accounts will be transmitted to the user's application device if specified information filtering and updating conditions are satisfied at 720. Newly updated information from subscribed landmark accounts will be automatically transferred to the user's terminal device at 724. Conditionally, a landmark subscriber can have the option to add and modify the information on the subscribed landmark account at 728. The process continues with other operations at 732. In general, the method of visiting a landmark information database from the user terminal is called landmark subscription method.

The most important location and event based information exchange and control method establish information and control access between a landmark and a user based on an event that is recognized between them. An event describes and specifies the relationships between a landmark place and a user from their absolute and relative time, geographic position and motion, behavior and activity, plus their identity information. When an event identified between a landmark and a user satisfies both the event criteria from the landmark account and the user account, information exchange and control access will be granted between them. This method realizes real-time onsite landmark information access by utilizing map based position and navigation system to determine the active landmarks and the information contents to be communicated. Furthermore, for event recognition, both global or local map data and navigation devices can be used. Typical navigation capable application terminal devices include GPS based navigation applications on a car, a smartphone or a tablet computer, etc.

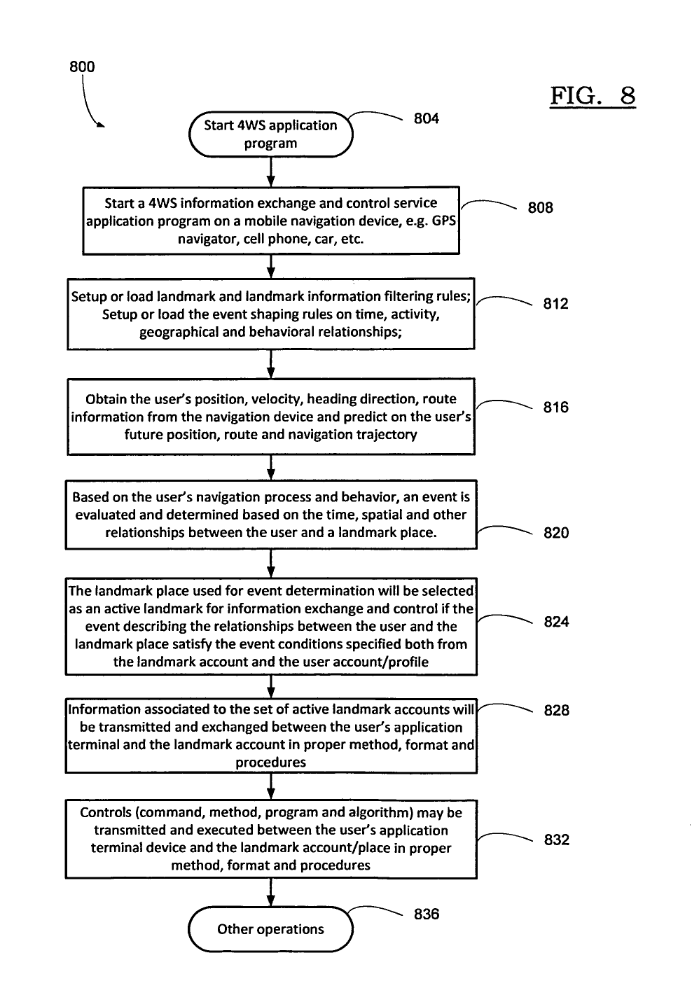

In general, the method of accessing landmark account and landmark information based on the spatial relationship between the user and the landmark as well as the user's navigation behaviors is called landmark navigation method. With reference to FIG. 8, this method is illustrated in accordance with one or more embodiments and is generally referenced by numeral 800. The method starts the 4WS service at 804 and its service application is loaded to one type of service terminal systems as in 250 with global or locally positioning capability at 808. Based on the user's account settings, landmark filtering rule and qualified event specifications are first loaded at 812. A user's navigation and motion data are then obtained as well as their derived information at 816. Events are then modelled and process to evaluate the geographical and behavioral relationship between the user and candidate landmarks at 820. Supporting conditions like time, environment, and weather may also be used in the event evaluation. Once the present conditions between a landmark and the user satisfies a prescribed event, the landmark will be selected as an active landmark for information exchange and control services at 824. The landmark is then successfully paired with the user and qualified information contents form the landmark account will be communicated to the user's terminal device system at 828. In addition, control operation may also be allowed and applied between the landmark system and the user's terminal system to achieve operation functions at 832. This process ends at 836. Furthermore, the landmark navigation method also supports trip-oriented landmark selection approach. In this manner, the landmark selection and activation is not only based on an event of a user's current position and behavior, but also based on the user predictive or planned future position as well as spatial, behavioral and time relationships with candidate landmark locations.

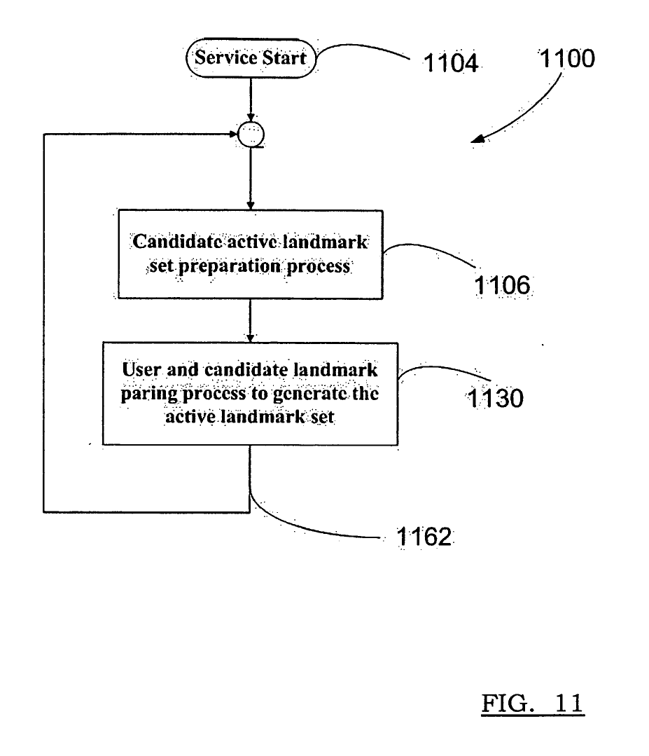

With reference to FIG. 11, a landmark and user matching process on LEPS is illustrated in accordance with one or more embodiments and is generally referenced by numeral 1100. The process primarily comprises two sub-processes: the candidate active landmark set preparation process 1106 and the user and candidate landmark pairing process 1130 to generate the active landmark set. Such process continues with the next cycle of processing at 1162.

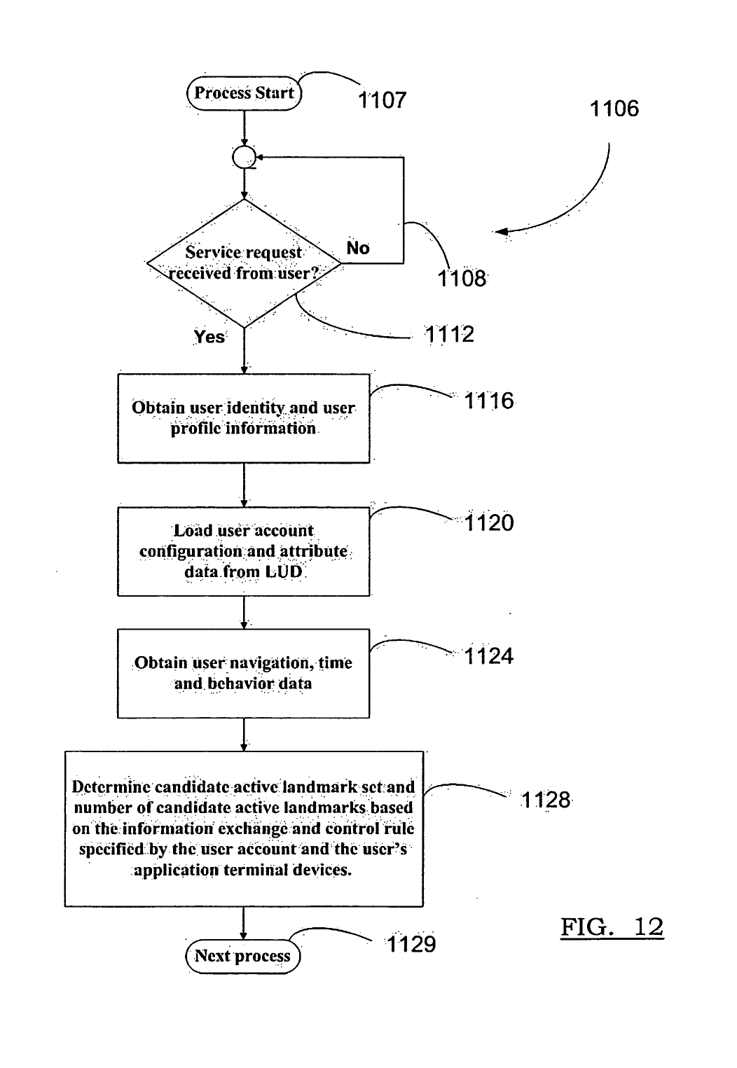

With reference to FIG. 12, a detailed process for the candidate active landmark set preparation process is illustrated in accordance with one or more embodiments and is generally referenced by numeral 1106. After the process starts 1107, LEPS 38 will monitor on service request at 1108 and 1112. Once received, it obtains user identity and profile at 1116 and loads user account configuration and attribute data at 1120. Next, the user's position, velocity, heading direction, route and future routes, navigation behavior and trajectory are obtained and derived from the data reported by the user's navigation device and associated applications at 1124. Next, based on the information exchange and control rule specified by the user, landmarks satisfying the specified identity, category and attribute properties are selected and added to the candidate active landmark set at 1128. For a simple example, restaurant landmarks in 5 kilometers range around a user are selected as candidate active landmarks when the user specifies landmark filtering rule as food service and nearby. This process ends at 1129.

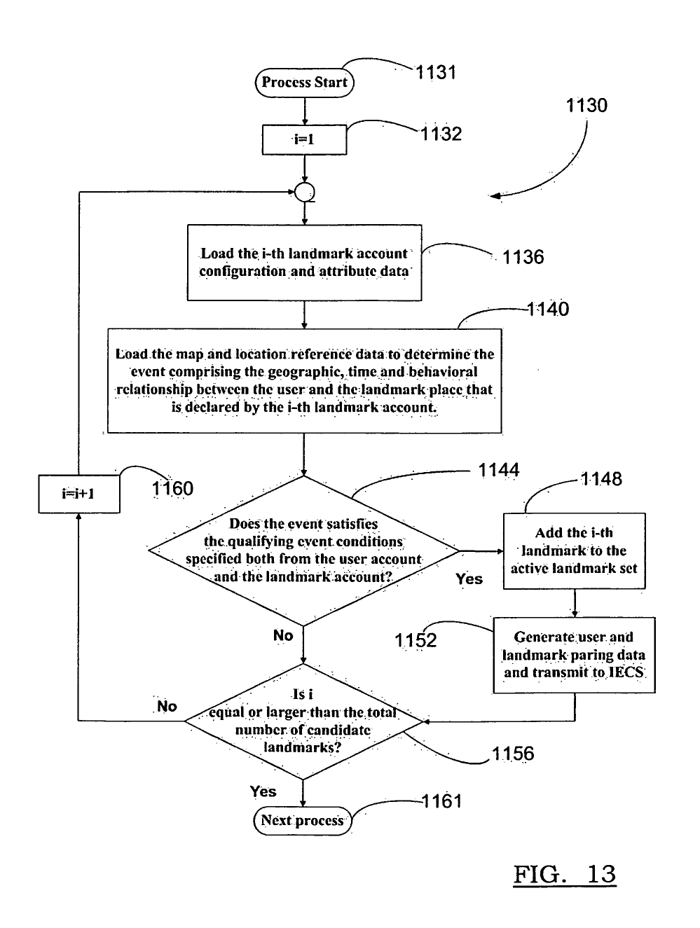

With reference to FIG. 13, a detailed process for the user and candidate landmark pairing process is illustrated in accordance with one or more embodiments and is generally referenced by numeral 1130. In this process, the relationship between each landmark in the candidate active landmark set and the user is evaluated to check if there is qualified event between them. The process starts with a first candidate landmark by setting the index parameter i=1 at steps 1131 and 1132. The landmark's identity, configuration and attribute data are then loaded at 1136. The process determines the present event that characterizes the relationship between the landmark and the user at 1140. An event comprises geographic relationship conditions as well as time and behavioral relationship conditions. Given the present event satisfies the qualifying event prescribed in both user account and the landmark account at 1144, this landmark will be added to the active landmark set at 1148. User and landmark pairing data are then generated to direct IECS in establishing communication and control connection between the landmark and the user accordingly at 1152. Such process is continued at 1156 and 1160 until all the candidate active landmarks are evaluated with the user in their event conditions. The process next continues with other process at 1161.

Based on the user's navigation data plus the declared landmark information and map data, an event will be recognized by LEPS 38 to characterize the time, spatial, behavioral and mutual relationships between the user and the registered landmarks. Some simple examples of events between a user and a landmark place include that a user is reaching (touching the location coordinates or boundary), crossing (entering, existing or moving inside the landmark location boundary), approaching (close to or towards) or staying inside the boundary of a landmark place. A more complicated event is defined with more conditions comprising absolute or relative time, duration, velocity and heading, user identity, etc. All of these conditions construct a where-when-who-what event shaping strategy to determine information exchange and control will be available and allowed between the user and a landmark place.

A landmark that has a recognized event satisfying both the event qualification conditions from the landmark account and the user account/profile will be selected to the candidate landmark set. After that, LEPS will start matching the information exchange and control availability and accessibility between the landmark and the user by screening the landmark and landmark information and control filtering rule from the user account as well as the those rules specified for a landmark account. A candidate landmark will be activated and authorized for information exchange and control service with the user once passing all the filtering rules on both sides. A user and landmark pairing data will be generated and sent to IECS to start the information exchange and control service. The user and landmark pairing data contains user account ID, terminal device profile and address, landmark account ID, landmark account address, information exchange service ID and content, control service ID and content, information exchange and control program ID, etc.

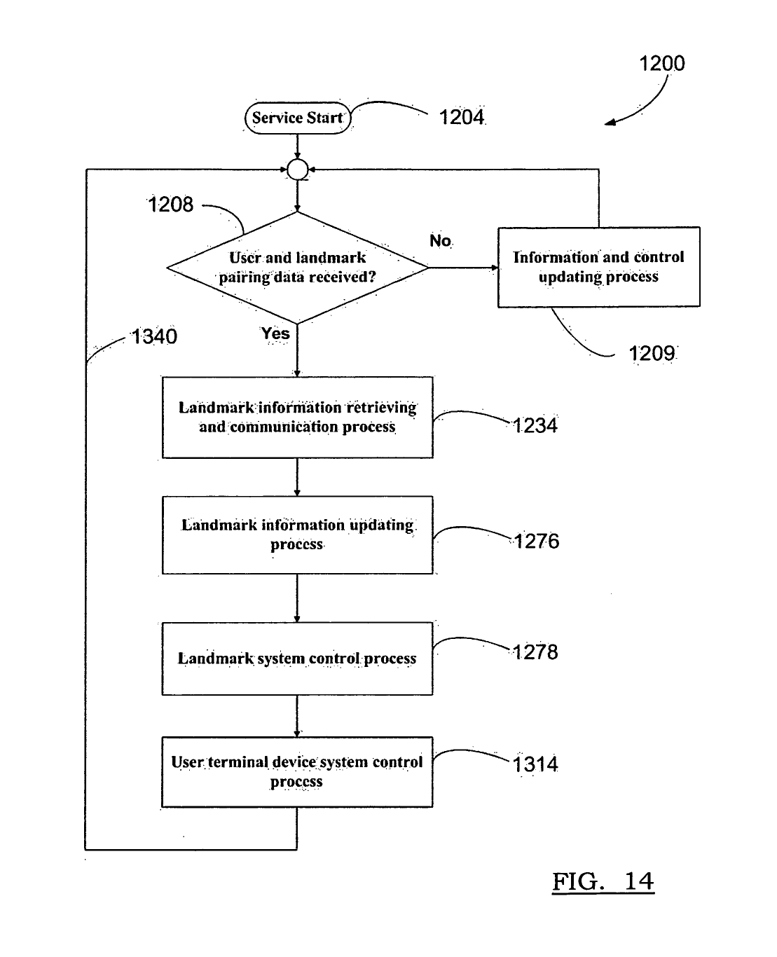

With reference to FIG. 14, a method for IECS information exchange and control 82 is illustrated in accordance with one or more embodiments and is generally referenced by numeral 1200. The method is implemented using software code contained within the service center system 86, according to one or more embodiments. In other embodiments, the method 1200 is implemented in the 4WS computing center, or distributed amongst multiple 4WS subsystems. The method 1200 processes the landmark related information and controls and manages their communication flow in the 4WS service network.

At operation 1204 the IECS server application starts. At operation 1208, it will wait for user and landmark pairing data. If not paring data received, it will switch to information and control updating process 1209. Otherwise, the process will continue with landmark information retrieving and communication process 1234. After that, the process will sequentially execute the landmark information updating process 1276, the landmark system control process 1278 and the user terminal device system control process 1314. The process returns to 1208 and wait for a new user and landmark pairing data at 1340.

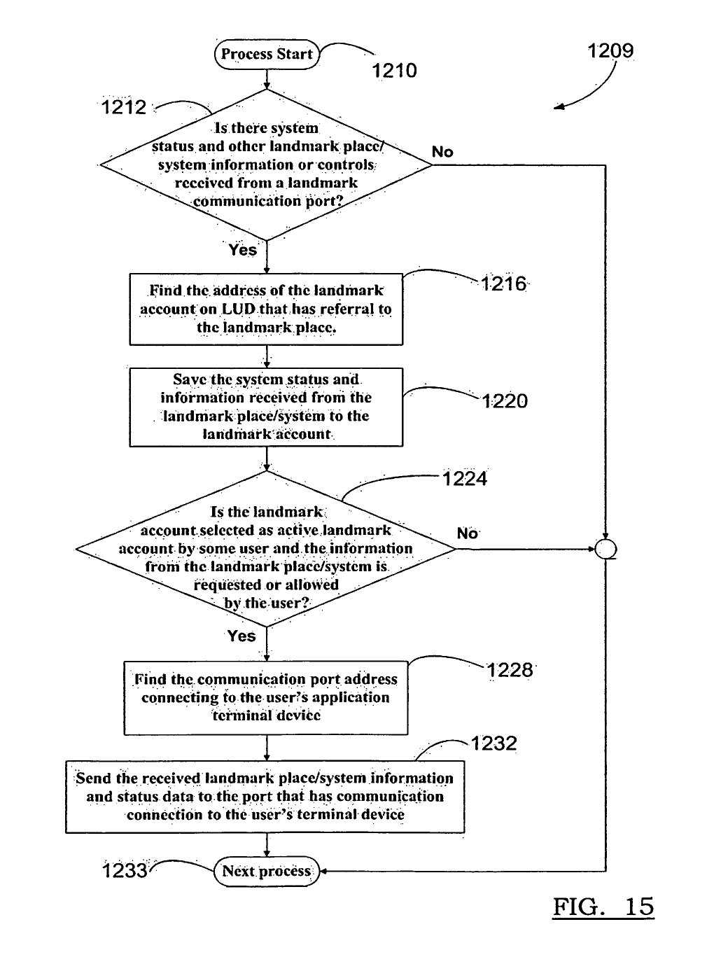

With reference to FIG. 15, a method for information and control updating process is illustrated in accordance with one or more embodiments and is generally referenced by numeral 1209. This process monitors on available communication ports to landmark places to check whether updated landmark place/system status and state data is received at operation 1212. If data received from a landmark place/system, IECS will find the corresponding landmark account on LUD at operation 1216 and save the received data to the landmark account at operation 1220. Next, IECS will check if the landmark account got updated is an active landmark subscribed by a user account/profile at operation 1224. If true, IECS will identify the communication port to the user and send the updated information from the landmark place/system to the user's application terminal device at operations 1228 and 1232. This process ends and continues to other process after 1232. Alternatively, it ends if no data received at 1212, or if the condition at 1224 is not true.

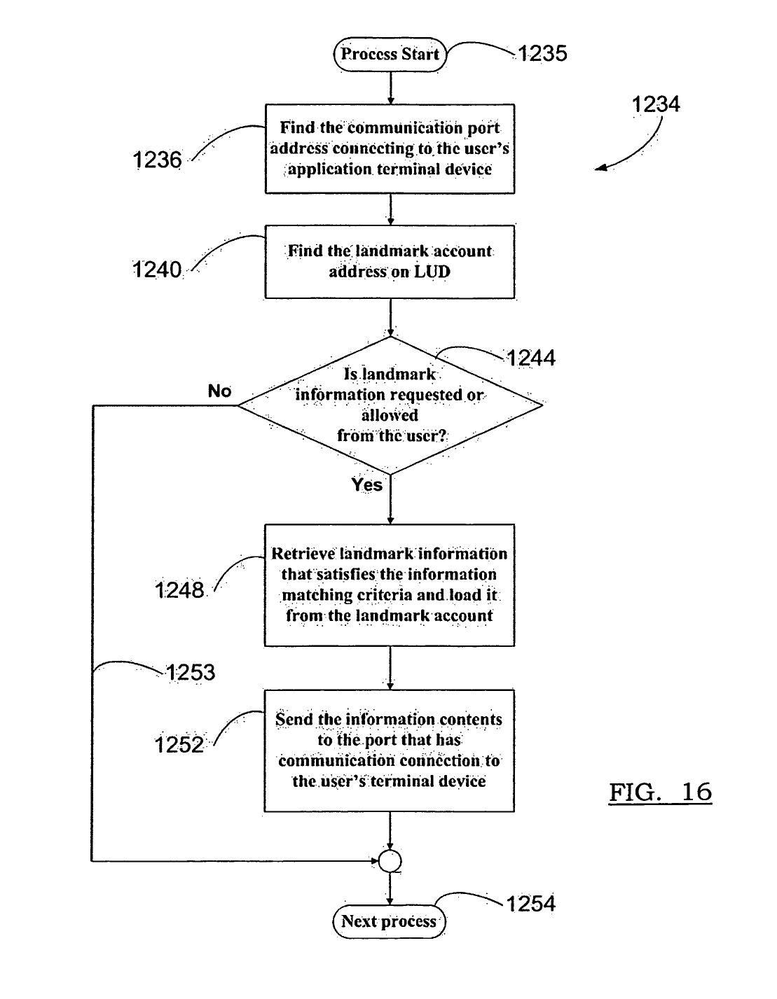

With reference to FIG. 16, a method for landmark information retrieving and communication process is illustrated in accordance with one or more embodiments and is generally referenced by numeral 1234. When user and landmark pairing data is received, IECS will find the user's communication port address and the landmark account address on LUD at operations 1236 and 1240. If the paring data indicates that landmark information is requested or allowed by the user at 1244, information from the landmark account will be loaded to IECS and transmitted to the user's application terminal device at operations 1248 and 1252. The process ends and continues to other process at 1254 after 1252 or if the condition at 1244 is not true.

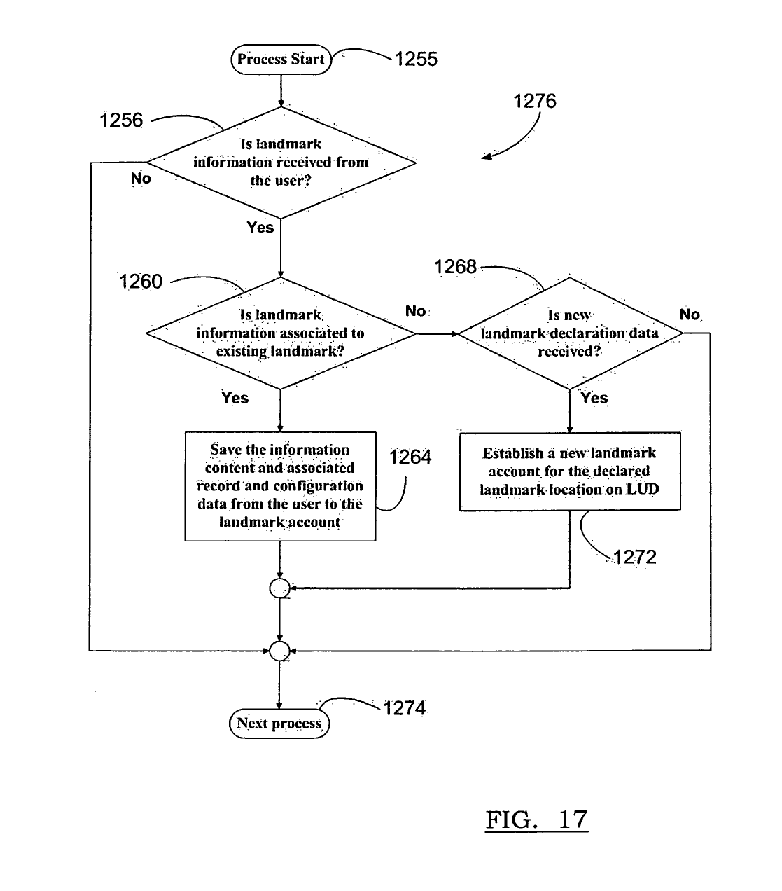

With reference to FIG. 17, a method for landmark information updating process is illustrated in accordance with one or more embodiments and is generally referenced by numeral 1276. If the paring data indicates that the user is sending data to the landmark account at operation 1256, IECS will further check if the data from the user is directed to an existing landmark account at operation 1260. After landmark account is confirmed, the data will be directed to the landmark account for further processing or storage at operation 1264. In the case that a user is requesting to declare a new landmark at operation 1268, a landmark account will be established at operation 1272 with storage space allocated and initial record created. The process ends and continues to other process at 1274.

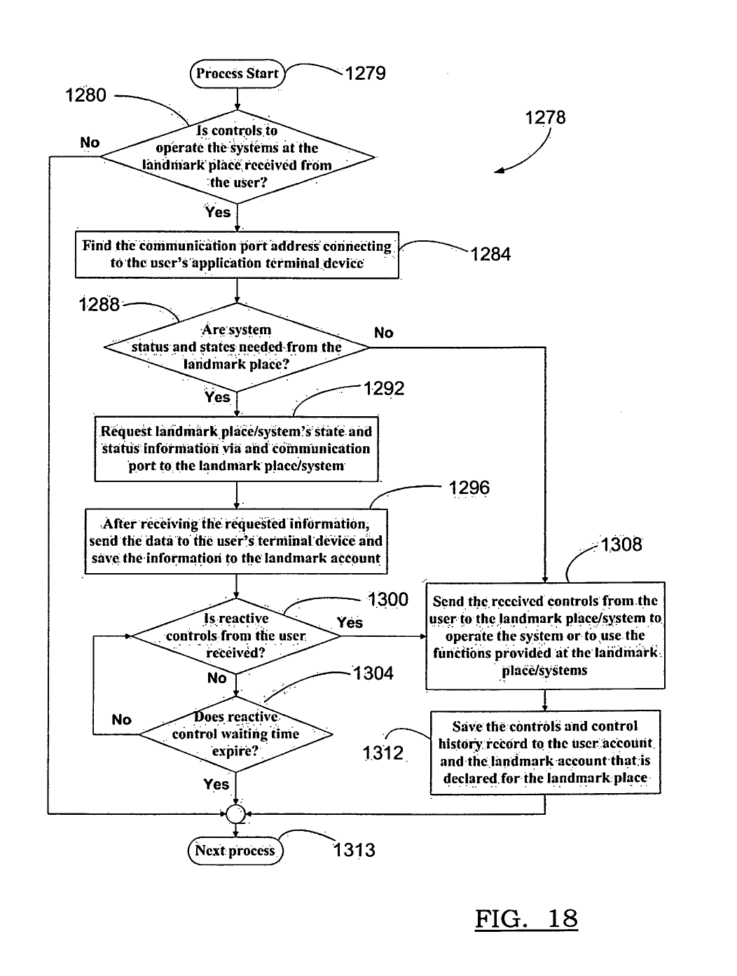

With reference to FIG. 18, a method for landmark system control process is illustrated in accordance with one or more embodiments and is generally referenced by numeral 1278. If the paring data indicates that controls to operate the system at the landmark place is requested by a user at operation 1280, IECS will find the communication port to the user's terminal application device at operation 1284 and then check if system status and state at the landmark place are required finish the control at operation 1288. If not, IECS will proceed to send the controls to the landmark place/system to be executed and save the corresponding records about this control activity to the landmark account at operations 1308 and 1312. On the other hand, if yes at operation 1288, landmark place/system's status and state will be requested and sent to the user's terminal device to execute the control procedure and algorithm at operations 1292 and 1296. After that, IECS will wait for the reaction from the user's terminal device. Once a reactive control instruction is received at operation 1300, IECS will continue to operations at 1308 and 1312. Otherwise, the operation will be terminated when a specified waiting timer expires at operation 1304. The process ends and continues to other process at 1313.

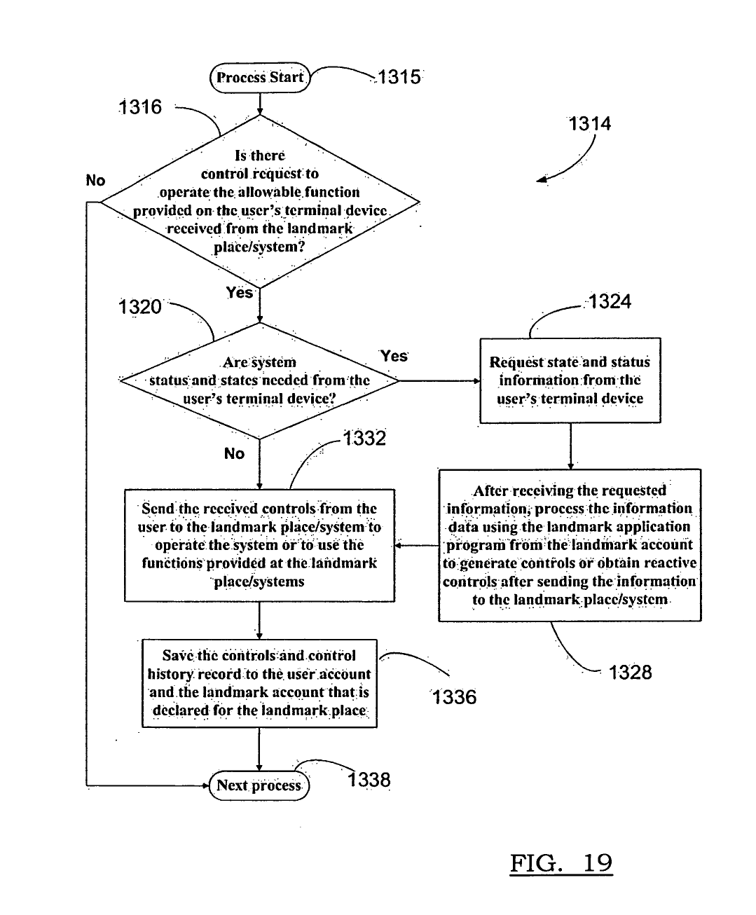

With reference to FIG. 19, a method for user terminal device system control process is illustrated in accordance with one or more embodiments and is generally referenced by numeral 1314. If the paring data indicates that control to operate the system at the user's terminal device is requested by the landmark place/system at operation 1316, IECS will further check if system status and state data from the system at the user's terminal device is needed to achieve the control procedure or command at operation 1320. If needed, such data will be requested and obtained from the system and application programs at the user's terminal device and sent to the control program either from the landmark account or from the landmark place/system at operations 1324 and 1328. After that, instructive or reactive controls from the landmark account or from the landmark place/system will be processed and sent to the control application program at the user's terminal device to operate the system connected to the user's terminal device at operation 1332. The corresponding record about the control execution process will be saved to the landmark account at operation 1336. After that, IECS will go to a new operation process loop at operation 1338 and 1340.

To better illustrate the landmark navigation method, several use cases are provided in the following sections as application examples.

When a 4WS service user sets landmark selection filter with category parameter “American restaurant”, all the landmarks that are in the category of “American restaurant” will be selected to the candidate landmark set if its landmark location is within 10 miles range around the user's current position. If the user's terminal device is a car with navigation and HMI devices, these candidate landmarks will be displayed on the map view within a map scale on the HMI device. The 4WS service terminal application program could be run on the vehicle's vehicle navigation computer. At this moment, none of the candidate landmark is active yet. While the vehicle is driving along a street, the vehicle is approaching a nearest candidate landmark location declared as McDonald's, which is a McDonald's restaurant at that place. This is a qualified event for information exchanging both allowed by the user and the landmark. Thus, the McDonald's restaurant landmark win the information exchanging right and its landmark information will be displayed to the vehicle navigation computer screen including today's menu item, running promotion, coupon, and a greeting voice or video message from the staff team.

A second exemplary use case is an interactive tour guide program called tour-pal. When a tourist is walking in a strange tourist city street, he/she has the landmark application program running on his/her smartphone. The tourist will get information and stories about a historical building when he/she is in front of or passing by the building, where the landmark location of the building is the closest one to the tourist's GPS position such that landmark information about the building is loaded and displayed to the tourist on his landmark application terminal. The information to be transmitted to the user is not limited to the information content on the landmark account. It can be information related to the landmark from external sites or database. For example, knowledge about a historical building can be obtained from Wikipedia when the user is taking a tour near the building. Such functionality help realizing real-time and on-site virtual tour guide.

Based on the tourist's behaviors and hints, the tour guide program can help the tourist to find interested places like stores, restroom, parking lot, restaurant, boarding place, ticket center, etc. By loading tour guidance application program on a user's smartphone, computer or vehicles from a travel agent landmark account or from local travel welcome office, a tour guide program can interactively guide the tourist on what to see and where to go as well as tour planning and budget planning based on the events exhibited by a tourist with respect to landmark places as well as time, destinations and connected travel plan.

A third exemplary use case for information exchanging is the advertisement along a highway. Highway advertising signs are traditionally used to tell drivers about nearby restaurant and places of interest. Only limited information can be transmitted and an advertisement can be easily missed for drivers with high workload. The 4WS service on the vehicle can help broadcast such advertisement electronically by recognizing an event between a vehicle and nearby declared landmarks. When a vehicle is approaching a highway exit 5 or 10 miles away, a restaurant landmark at the high way exit place can be activated to transmit restaurant and promotion information to the user in the vehicle. When a user is driving a vehicle passing a historical site of memorial, the 4WS service application will active the landmark account of the memorial site landmark and tell the story about the place to the driver. With the 4WS service, a driving trip becomes much more fun and interactive along the road. A driving trip also becomes a trip of leaning and social activity. The cost on advertisement is large reduced and the contents of advertisement become more entertaining and variable.

In the 4WS information exchange and control applications, multiple landmarks may be qualified for information exchange and control service based on the location and event recognition strategy plus landmark and landmark information filtering rules. When information exchange resource (duration, amount of data, displaying space, etc.) is limited, the determination of final resource-wining landmarks may also depends on the landmark and landmark information priority, type and customer's reviews on the landmark account or service provided at the landmark place. A low ranking landmark will have less and less chance to win information exchange or control service with 4WS users.

An exemplary use case to demonstrate the control operation on a landmark place/system is presented with traffic light and road light control system. A road is declared as a landmark and the lights along the road are components of a lighting system that can be controlled from external control command. In the evening, lights along the road are off or dimed to save energy while traffic is sporadic. A 4WS service user can have the road landmark active while walking along the road or by selected the road landmark actively. Control access on the lights will be given to the 4WS service application program on the server and on the user's terminal device. By obtaining the user's current position form his/her 4WS application terminal device, the light control program will fully turn on the lights in 200 meters range around the user. By further deriving the user's heading direction and velocity, more lights will be turned on in front of the user. As the service user is moving forward, lights go outside of 200 meters range around the user will be turned off or dimed again. With such 4WS landmark place control service, energy for road lighting is largely saved without leaving any person in dark or danger.

An exemplary use case to demonstrate the control operation from a landmark account on a user's application terminal device is presented by a vehicle's speed control and emission control functions. When a 4WS service user is driving a vehicle entering a speed control zone where speed limit is strictly regulated and speed limit may change from time to time, the declared speed control zone landmark will be activated for the vehicle based on an event recognized that the vehicle is in this zone. The speed limit information saved in the landmark account will be transmitted to the vehicle to trigger a speed limit control function of the vehicle. As a result, the function will supervise the driver to avoid exceed the speed limit while driving within the speed limit control zone. When a 4WS service user is driving a vehicle in a hilly scenic region that has been declared as a landmark, the landmark account may contain a control program that have access to supervise the emission control process for vehicles that is operating within scenic landmark region. Based on a vehicle's position, velocity and heading direction, the emission control program from the landmark account will transmit instantaneous humidity, temperature, air quality and road grade information to the vehicle to adjust the vehicle's powertrain control state and algorithm to minimize certain exhaust components and concentration. Similarly, a regional landmark can also use local and updated road frictional condition and visibility to adjust the stability control state and algorithm to improve the stability and safety control performance for vehicles that is operating in the landmark region. A highway landmark can use 4WS service to regulate jammed traffic with instruction on the motion of each vehicle involved in a traffic jam or accident to quickly release the blocked road without the involvement of policemen, which is a very important and useful function in bad weather conditions.

Examples of a moving or short-term landmark place can be server weather zone, tornado zone, criminal zone, emergency control zone, etc. In these types of moving landmark information account with temporary or varying geographic region coverage, 4WS service user inside or near these zones will receive active warning about what is happening, what will happen, what action shall be taken and detailed instructions on what to do at where, even though the 4WS service users affected may not percept any occurrence or danger condition by themselves.

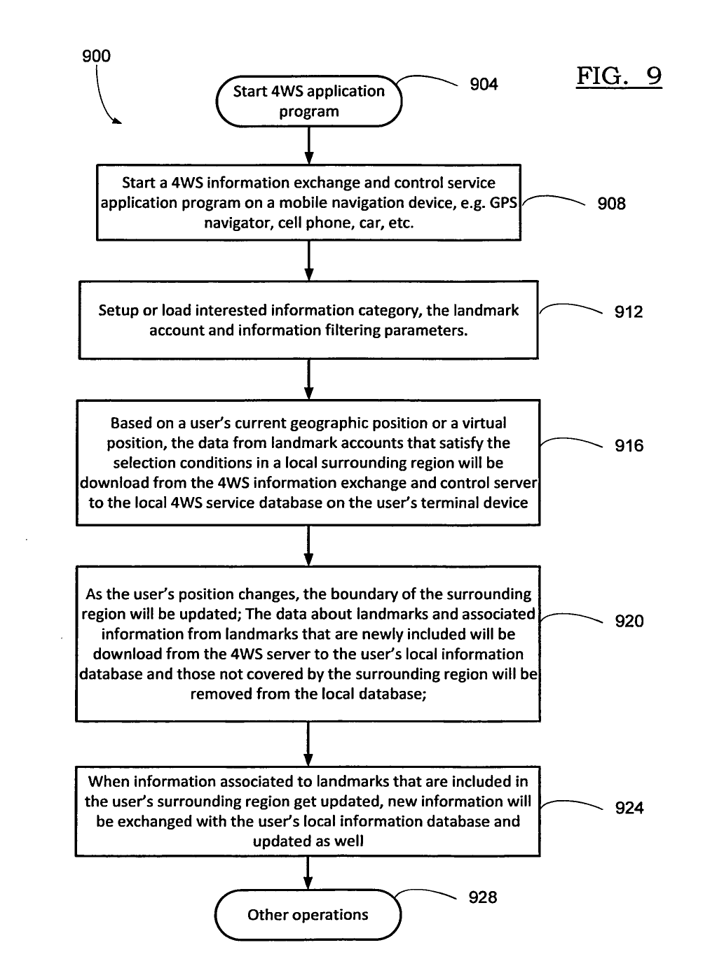

In this mobile compatible landmark data access method, there are different ways of transmitting the landmark information to the user's application device. The first method utilizes real-time information exchanging between the service center system and the terminal application device through wireless communication network. Landmark information will only be transmitted after a landmark is selected active. With reference to FIG. 9, a method for local landmark database updating process is illustrated in accordance with one or more embodiments and is generally referenced by numeral 900. After start 4WS application at 904 and service at 908, a service user setup or load filtering parameter to specify classes of interested landmarks at 912. Landmark information will be downloaded from landmark database to local landmark database for surrounding landmarks from the selected classes and at the user's present location at 916. The local landmark database will update accordingly as the user's surrounding region changes when the user moves at 920. Information for landmark that is now outside the surrounding region will be removed from the local landmark database and information for landmark that is now appeared in the surrounding region will be added to the local landmark database at 924. The process ends and continues with other operations at 928.

The second method generates a local landmark information database on the landmark application terminal device. Such local landmark database contains a copy of all or a subset of landmark information from landmarks that satisfy certain GPS position oriented filtering rules. For example, based on the user's present GPS location, all the landmarks within a region in 100 km radius surrounding the user's location are included. And the landmark information from all these accounts will be downloaded to the local landmark database. The advantage of this method avoids landmark application's dependence on the wireless network. When a target landmark is selected, its information can be retrieved from the local landmark information database for terminal application usage. Such database can be updated and synchronized with the landmark information center when network connection to the landmark information center is available and allowed. This method can accelerate the landmark application program and it also helps minimizing data exchanging cost.

When operating in the trip-oriented mode, a route from the current location to the destination is first specified. Landmarks in 5 km range along the route will be downloaded to a local landmark information database. Based on the user's navigation information selection, landmark information satisfying certain distance and category criteria will be loaded on the device and communicated to the user.

Similar to the second method, the third method applies local landmark information database. The only difference is that the local database is not constructed on the terminal device nor exchanged with the landmark application center, but it is loaded from external data storage device like memory disks or USB jump drives.

The landmark navigation method also supports information upload from the user's terminal after information exchanging channel is connected to the landmark account. However, this function requires the wireless network support. When the local database is used, such functionality is limited to non-interactive information that can be uploaded and synchronized to the landmark account in a later time.

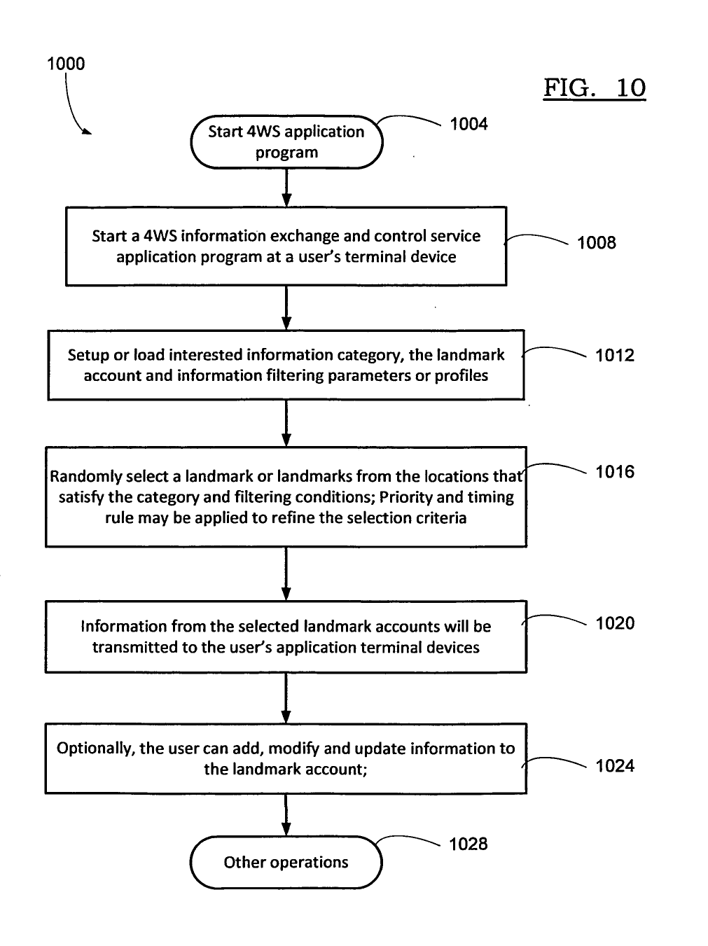

In addition to the landmark subscription method and landmark navigation method, a landmark broadcasting method is also used. In this method, the user does not book any landmark information by selecting a portfolio of interested accounts, nor will the user use navigation rule to select an active landmark. Instead, the user only setup a landmark account filter that has certain parameters that specify landmark category, property, type, attributes, time, distance to the user, etc. A landmark out of the filtered landmark set will be selected and it will win the information exchanging right with the user's terminal devices by some machine rules. An exemplary machine rules is random selection. With reference to FIG. 10, a method for landmark filtering and selection process is illustrated in accordance with one or more embodiments and is generally referenced by numeral 1000. After start 4WS application at 1004 and service at 1008, a service user setup or load filtering parameter to specify classes of interested landmarks at 1012. Active landmark for information exchange and system control services with the user will be randomly selected from the classes at 1016. Active landmark starts communicating information and application with the user at 1020. Optionally, the user can contribute information and application to the selected active landmark account at 1024. The process ends and continues with other operations at 1028.

Furthermore, an information zone can be declare by a landmark with location, region and boundary specified such that certain type and category of information can be broadcasted to all the users or applied to all the user's application terminal devices inside this zone. One example is the community information zone where information about a community is broadcast to its residents' landmark application like a radio station with the advantage that the residents have the right and freedom to exchange information and the information can be limited to the region covering only the community members. Another example is a regulation zone, like a low speed zone, in which all vehicles will receive a speed limit command such that they shall all be operated under that speed threshold or they will be forced to work in low speed mode (commanded no acceleration when the vehicle speed is higher than the specified limit).

As demonstrated by the embodiments described above, the 4WS information exchange and control system, and location and event based information resourcing method provide advantages over the prior art by building up direct connection between the information subject, the information resource and the information user. By evaluating a number of relationships between a landmark place and a user, the information in need will be able to transmitted to the users who indeed looking for information services.

While the best mode has been described in detail, those familiar with the art will recognize various alternative designs and embodiments within the scope of the following claims. Additionally, the features of various implementing embodiments may be combined to form further embodiments of the invention. While various embodiments may have been described as providing advantages or being preferred over other embodiments or prior art implementations with respect to one or more desired characteristics, those of ordinary skill in the art will recognize that one or more features or characteristics may be compromised to achieve desired system attributes, which depend on the specific application and implementation. These attributes may include, but are not limited to: cost, strength, durability, life cycle cost, marketability, appearance, packaging, size, serviceability, weight, manufacturability, ease of assembly, etc. The embodiments described herein that are described as less desirable than other embodiments or prior art implementations with respect to one or more characteristics are not outside the scope of the disclosure and may be desirable for particular applications. Additionally, the features of various implementing embodiments may be combined to form further embodiments of the invention.

What is claimed is:

1. A method for landmark based information exchange and system control services in an information system comprising:
defining a location with geometric shape using map coordinates.
declaring a landmark for said defined location and registering a landmark account for said declared landmark for storing information and applications.
forming at least one information access rule for said landmark account, wherein each of said information access rule associates a set of information and applications on said landmark account with a relationship condition;
determining a relationship between a service user and said landmark and verifying said relationship satisfies one of said relationship conditions for which access to associated set of information and applications is authorized;
establishing information service connection between said user and said landmark; and
permitting said user to access said landmark account for services on authorized information contents and applications.

2. The information access rule of claim 1, wherein said relationship condition is a subscription condition through which a service user subscribes information and application services from said landmark account.

3. The information access rule of claim 1, wherein said relationship condition is a filtering condition through which a service user accepts qualified information and application services provided from said landmark account.

4. The information access rule of claim 1, wherein said relationship condition is an event condition through which a service user accesses information and application services from said landmark account under prescribed event.

5. The event condition of claim 4, wherein said prescribed event defines relationship situations between said landmark and said service user. Each of said relationship situations comprises at least one circumstance from social relationship, spatial relationship, time relationship, behavioral relationship, environmental relationship and transportation relationship.

6. The method of claim 1, further comprising:
permitting said user to access control systems at said declared landmark location for services on authorized information contents and applications.

7. The method of claim 1, further comprising:
creating and managing a plurality of landmark accounts, each landmark account has unique landmark identity attributes with identifying location and shape defined by at least one declared stationary or dynamic landmark.

8. A method for event based information exchange and system control service in a landmark based information service system comprising:
creating a user account for a user to use said information service system.
forming at least one event for said user account, wherein each of said events associates a class of information and application with a relationship situation;
determining position for said user;
determining a relationship situation between said user and a landmark wherein said relationship situation comprises spatial relationship between said user position and said landmark location;
for said user account, verifying said determined relationship situation satisfies one of said events for which access to associated class of information and application is permitted;
establishing information service connection between said user and said landmark; and
permitting said landmark account to provide services on information and applications that belong to the permissible class to said user.

9. The method of claim 8, wherein said service user gets access to said information service system using a client terminal device system.

10. The method of claim 8, wherein said landmark location is determined by the defining location attribute of said declared landmark of claim 1.

11. The method of claim 8, wherein said user position is determined based on received navigation data from said client terminal device system of claim 9.

12. The said event of claim 8, wherein said relationship situation further comprises relationship circumstance from social relationship, spatial relationship, time relationship, behavioral relationship, environmental relationship and transportation relationship.

13. Apparatus for providing landmark based information exchange and system control services comprising:
a service center system;
a client terminal device system;
a telecommunications network for connecting said clients terminal systems to said service center system, wherein each of said client terminal device system has a network address; and
a map information database for storing map information and providing map data to other applications;

14. The apparatus of claim 13, wherein said map information comprise position and navigation data defined with respect to geographic, local, or virtual coordinate systems.

15. The apparatus of claim 13, wherein said telecommunications network comprises wired and wireless communication networks including computer networks, radio networks, and local area communication and control networks.

16. The apparatus of claim 13, wherein said service center system comprising:
memory;
at least one processor operably coupled to said memory and said telecommunications network, the processor is configured to execute a program of instructions, wherein said program of instructions comprising:
instruction to define and declare a landmark using services based on said map information database and application server;
instruction to register landmark account and user account;
instruction to configure landmark account and user account;
instruction to manage and maintain landmark and user database.
at least one computer program product that, when executed, causes actions of said service center system comprising:
determine the relationship condition between landmark and service user;
generate service pairing result for landmark and service user, wherein said service pairing result specifies on accessible information and applications and the methods of using them;
establish communication connection for paired landmark and service user; and
transmit information and applications between paired landmark and service user.

17. The apparatus of claim 13, wherein said client terminal device system comprising:
a navigation devices receives signals from which service user's navigation data are generated;
a computerized device for communicating and processing information and applications as well as for communicating the processing results to the service user;
memory;
at least one processor operably coupled to said memory and said telecommunications network, wherein said processor is configured to execute information exchange and system control service programs.

18. The client terminal device system of claim 17, wherein said navigation device determines the service user's navigation data with respect to at least one of the defined geographic, local or virtual coordinate systems of claim 14.

19. The client terminal device system of claim 17, wherein said computerized device is at least one of the devices among portable computer devices, mobile computer devices, transportable system embedded computer devices, and stationary computer devices.

20. The client terminal device system of claim 17, wherein said computerized device has associated control systems for providing control, communication and other application functionalities.
